(19) United States
(12) Patent Application Publication
(10) Pub. No.: US 2013/0097091 A1
(43) Pub. Date: Apr. 18, 2013

(54) METHOD AND APPARATUS FOR GENERATING AUDITING SPECIFICATIONS

(71) Applicants: Debmalya BISWAS, Lausanne (CH); Pentti Valtteri NIEMI, Naantali (FI)

(72) Inventors: Debmalya BISWAS, Lausanne (CH); Pentti Valtteri NIEMI, Naantali (FI)

(73) Assignee: Nokia Corporation, Espoo (FI)

(21) Appl. No.: 13/275,614

(22) Filed: Oct. 18, 2011

(51) Int. Cl. G06Q 10/00

(52) U.S. Cl. 705/317

(57) ABSTRACT

An approach is provided for generating auditing specifications. The compliance platform processes and/or facilitates a processing of one or more data collection policies to determine one or more specifications that specify, at least in part, data to log for determining a compliance with the one or more data collection policies (e.g., based on minimizing an amount of the data to log). Then, the compliance platform causes, at least in part, an installation of the one or more specifications at one or more data stores operating under the one or more data collection policies to cause, at least in part, an initiation of a logging of the data.

### BACKGROUND

Service providers and device manufacturers (e.g., wireless, cellular, etc.) are continually challenged to deliver value and convenience to consumers by, for example, providing compelling network services. One area of interest has been the development of services and technologies for auditing according to privacy policies and for data usage control. For example, in recent years, the prevalence of smartphones has led to an ever increasing amount of personal user data being collected by the mobile devices, applications, service providers, etc. Privacy policies, for instance, are implemented by service providers to ensure to users that their collected personal data will only be utilized in certain ways or for particular purposes. Auditing specifications for logging data related to transactions associated with the collected personal data are typically manually produced for such privacy policies. A privacy officer, for instance, must write the auditing specification, determine and select particular data to be logged, etc. As such, the production of these auditing specifications can be a tedious and complicated process.

### Some Example Embodiments

Therefore, there is a need for an approach for generating auditing specifications.

According to one embodiment, a method comprises processing and/or facilitating a processing of one or more data collection policies to determine one or more specifications that specify, at least in part, data to log for determining a compliance with the one or more data collection policies. The method also comprises causing, at least in part, an installation of the one or more specifications at one or more data stores operating under the one or more data collection policies to cause, at least in part, an initiation of a logging of the data.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of one or more data collection policies to determine one or more specifications that specify, at least in part, data to log for determining a compliance with the one or more data collection policies. The apparatus is also caused to install the one or more specifications at one or more data stores operating under the one or more data collection policies to cause, at least in part, an initiation of a logging of the data.

According to another embodiment, a computer-readable storage medium carries one or more sequences of one or more instructions which, when executed by one or more processors, cause, at least in part, an apparatus to process and/or facilitate a processing of one or more data collection policies to determine one or more specifications that specify, at least in part, data to log for determining a compliance with the one or more data collection policies. The apparatus is also caused to install the one or more specifications at one or more data stores operating under the one or more data collection policies to cause, at least in part, an initiation of a logging of the data.

According to another embodiment, an apparatus comprises means for processing and/or facilitating a processing of one or more data collection policies to determine one or more specifications that specify, at least in part, data to log for determining a compliance with the one or more data collection policies. The apparatus also comprises means for causing, at least in part, an installation of the one or more specifications at one or more data stores operating under the one or more data collection policies to cause, at least in part, an initiation of a logging of the data.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at leak one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of generating auditing specifications, according to one embodiment;

FIG. 2A is a diagram of the components of a compliance platform, according to one embodiment;

FIG. 2B is an illustration of a flowchart using the components of a compliance platform, according to one embodiment;

FIG. 2C is an diagram of various details that may be extracted from an audit output file, according to one embodiment;

FIG. 3 is a flowchart of a process for generating auditing specifications, according to one embodiment;

FIG. 4 is a flowchart of a process for providing auditing specifications based on contextual parameters, according to one embodiment;

FIG. 5 is a flowchart of a process for generating compliance notifications and reports, according to one embodiment;

FIGS. 6A and 6B are diagrams of user interfaces utilized in the processes of FIGS. 3-5, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for generating auditing specifications are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

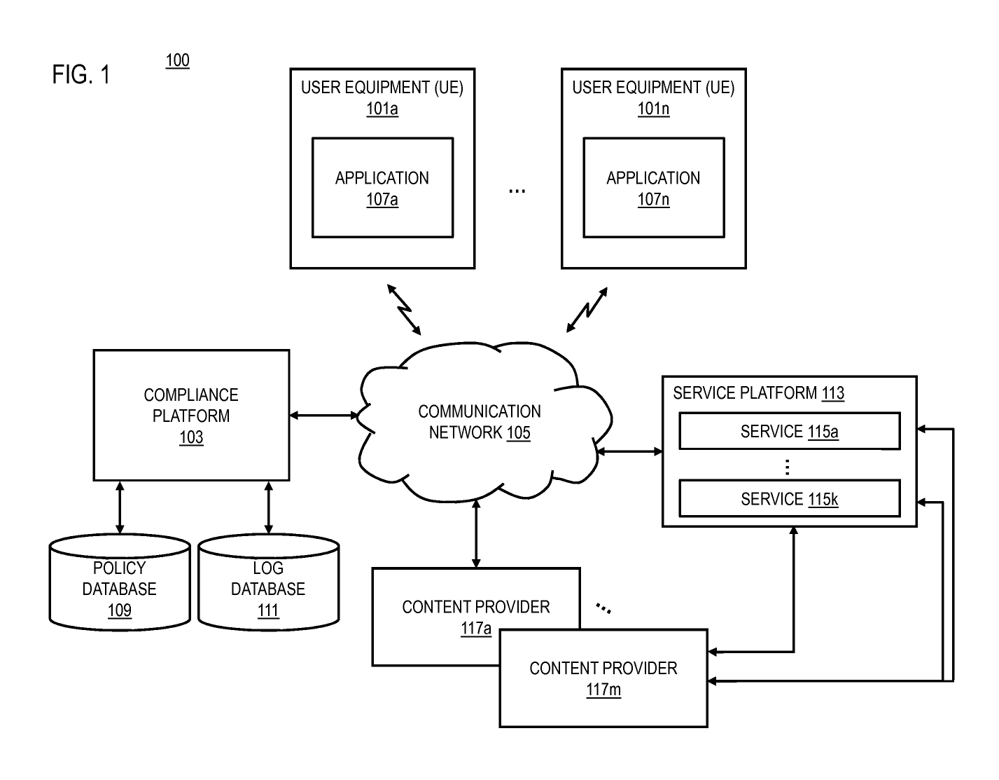

FIG. 1 is a diagram of a system capable of generating auditing specifications, according to one embodiment. With more and more personal data being collected and stored by service providers, there is an increasing need to ensure that their usage is compliant with privacy policies (as well as well as security policies, performance policies, etc.). These privacy policies, for instance, are often implemented by service providers to promise to end-users that their collected personal data will only be utilized in certain ways or for particular purposes. Moreover, data usage control is typically employed to verify compliance with respect to the privacy policies. One of the primary ingredients for such an auditing process is the availability of sufficient data logs regarding transactions associated with the collected personal data. As mentioned, the production of auditing specifications to generate the data logs can be a tedious and complicated process. A privacy officer may, for instance, have to manually write the auditing specification, determine and select particular data to be logged, etc. In addition, the data logs generated by such auditing specifications can become increasingly large. A larger data log may not only lead to longer execution time for compliance verification using the data logs (e.g., comparing the data logs against the privacy policies), but may also decrease real-time database performance (e.g., if auditing is turned on).

To address this problem, a system 100 of FIG. 1 introduces the capability to generate auditing specifications specifying data to log for compliance with respect to particular data collection policies. It is noted that although various embodiments are described with respect to compliance with privacy policies, it is contemplated that the approach described herein may be used with other policies, such as security policies, performance policies, etc. By way of example, the system 100 may process a data collection policy to determine an auditing specification that specifies data to log, which may be utilized to determine compliance with the data collection policy. As indicated, the data collection policy may include a privacy policy, a security policy, a performance policy, etc. The auditing specification may then be installed at data stores operating under the data collection policy to initiate a logging of the data. The logging of the data may, for instance, commence upon the installation of the auditing specification at the data stores since the data to log is already specified in the auditing specification. Moreover, the processing of the data collection policy, the generation of the auditing specification, and the installation may be an automated process, the details of which will be further explained below. In this way, a privacy officer would not need to manually write the auditing specification, or manually determine and select the particular data to be logged, since the auditing specification may be automatically generated without user action upon, for instance, receipt of the data collection policies for processing. The data to log may include data related to operations performed on the data stores including transfers, modifications, utilizations, accesses, etc. The data stores may include information or content collected from user devices, associated applications, etc., as well as other data associated with the collected information or content.

As shown in FIG. 1, the system 100 comprises a user equipment (UE) 101 (or UEs 101a-101n) having connectivity to a compliance platform 103 via a communication network 105. The UE 101 may include or have access to an application 107 (e.g., applications 107a-107n) to enable the UE 101 (e.g., a policy manager's user device) to interact with, for instance, the compliance platform 103 to: (a) process data collection policies to determine specifications specifying data to log for compliance with the data collection policies; (b) install the specifications at the data stores operating under the data collection policies to initiate logging of the data; (c) process the data for comparison against the data collection policies, the specifications, etc., to determine the compliance with the data collection policies; (d) generate notifications, reports, etc., with respect to the compliance with the data collection policies; (e) or perform other functions. The compliance platform 103 may include or have access to a policy database 109 to access or store policy information (e.g., data collection policies, auditing specifications, etc.) associated with users, devices, applications, data stores, etc. The compliance platform 103 may also include or have access to a log database 111 to access or store data logs associated with the data collection policies, the auditing specifications, etc. Collected information or content may be obtained or stored at data stores located at the policy database 109, the log database 111, a service platform 113, one or more services 115 (or services 115a-115k), one or more content providers 117 (or content providers 117a-117m), and/or other services available over the communication network 105. It is noted that the compliance platform 103 may be a separate entity of the system 100, a part of the one or more services 115 of the service platform 113, or included within the UE 101 (e.g., as part of the application 107).

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In another embodiment, the data may be processed and compared against the one or more data collection policies and/or the one or more specifications to determine the compliance with the one or more data collection policies. By way of example, data related to the one or more operations performed on the one or more data stores by one or more applications, one or more services, one or more third parties, etc., may be compared against one or more policy-monitored operations to determine whether the one or more performed operations are in compliance. In one scenario, the data collection policies associated with a particular data store may forbid transfers of collected user-identifiable information to third parties. As such, the data collection policies may require removal of collected user-identifiable information from a subset of collected user data prior to the transfer of that subset a third party. Accordingly, such data transfers to third parties may be monitored for user-identifiable information to determine compliance with the data collection policies.

In another embodiment, one or more notifications and/or one or more reports with respect to the compliance with the one or more data collection policies may be generated. In one use case, there may be various levels of treatment for different non-compliant operations. For example, transfers of user-identifiable information to third parties may be subject to a higher level of scrutiny, as compared with transfers of collection information that does not include any user-identifiable information. As such, a transfer of user-identifiable information to third parties (e.g., even transfers permitted by a high-level policy manager) may trigger a notification that includes information relating to the particular transfer to be generated and transmitted to all high-level policy managers. The information relating to the particular transfer may, for instance, include the policy officer who initiated the data transfer, the high-level policy manager who permitted the data transfer, the user-identification information included in the data transfer, the third party receiving the data transfer, etc.

In another embodiment, the one or more specifications may be determined based on minimizing an amount of the data to log. By way of example, the amount of the data to log may be minimized based on one or more operation types, one or more parameter values, one or more database instances, etc. In one use case, the data to log for various database instances may be limited to “insert” operations. By way of another example, the amount of data to log may be minimized based on one or more contextual parameters. The one or more contextual parameters may, for instance, include one or more temporal parameters, one or more location parameters, and/or one or more activity parameters. Thus, the one or more specifications may be based on the one or more contextual parameters to minimize the amount of the data to log. In this way, execution time associated with compliance verification (e.g., part of data usage control) as well as the negative effect on real-time database performance may be reduced.

In another embodiment, the one or more data collection policies may be determined to be in a predetermined format, a policy language, and/or a high level language. The one or more data collection policies may then be parsed according to the predetermined format, the policy language, and/or the high level language to determine the one or more specifications. In one scenario, the one or more data collection policies may include Metric First Order Temporal Logic (MFOTL) language. As an example, predicates (e.g., tokens) in a given MFOTL policy may be extracted by passing the MFOTL policy and a MFOTL regular expression as an input string and an input pattern respectively to a parser function for generating the one or more specifications. In some cases, the predicates may be further filtered to extract the type of operations, database instances, and parameters values to be monitored.

In another embodiment, one or more contextual parameters associated with the one or more data collection policies may be determined. The one or more specifications may then be determined based on the one or more contextual parameters. As mentioned, the one or more contextual parameters may include one or more temporal parameters, one or more location parameters, and/or one or more activity parameters. By way of example, the determined specifications may include a time-based mechanism to enable or disable logging based on the temporal parameters in the respective one or more data collection policies to be monitored. In one scenario, while logging all “insert” operations in a particular table of various database instance may be sufficient for a certain purpose, the logging of the data may be further minimized based on temporal parameters. Logging an “insert” operation, for instance, in a table t₁ in a particular database instance may be irrelevant with respect to evaluating the associated data collection policy if the “insert” operation did not occur within a predetermined time period (e.g., thirty minutes) for the table t₁ of another database instance. As such, the particular “insert” operation may not be logged based on the determined specifications. By way of another example, the one or more data collection policies may include the policy that “No user activity information should be collected when the user is in the office.” In MFOTL, such policy may written as the following: update[1](u, location, ‘office’)→NOT insert[1](u, activity, null), where u represents the user, location and activity represents respective tables, and ‘office’ represents the location parameter (e.g., the location parameter unit is of the granularity ‘home,’ ‘office,’ ‘supermarket,’ etc.). If, for instance, this policy is the only policy defined on the location table, then it may be sufficient to only log “update” operations on the location table with the value ‘office.’

In another embodiment, the data and/or the logging of the data may be monitored based on the one or more contextual parameters. In one use case, one or more entries of one or more data logs may be generated based on the logging of the data. The one or more entries may, for instance, be iteratively processed to determine the compliance (or non-compliance) with the one or more data collection policies. As the one or more entries are being processed, a collection including a subset of the one or more entries may be maintained with respect to certain operations performed on the one or more data stores (e.g., operations satisfying the one or more temporal parameters). Additionally, or alternatively, entries may be discarded from the collection whenever the entries become irrelevant for detecting further violations of the one or more data collection policies.

For the purpose of illustration, the following MFOTL scenario, with a semantics based on timed temporal structures, is provided:
A (first-order) signature S is a triple (C, R, a), where C is a set of constant symbols, R is a finite set of relation symbols, and a: R→N associates each relation symbol sεR with an arity a(s)≧1. A (relational) structure D over the signature S=(C, R, a) consists of a domain |D|≠ and interpretations c^{D}ε|D| and r^{D} ⊂|D|^{a(r)}, for each cεC and rεR. A timed temporal structure is a sequence of relational structures over the same signature, where each relational structure is associated with a time stamp.

In this scenario, a timed temporal structure associates with each time point pᵢεP a structure Dᵢ and a time stamp τᵢ. While the sequence D=(D₀, D₁, . . . ) provides a qualitative ordering on the individual structures, the sequence of time stamps τ=(τ₁, τ₁, . . . ) associates each structure Dᵢ with quantitative time information, where adjacent time points pᵢ and pᵢ₊₁ can have equal time stamps (e.g., τᵢ=τᵢ₊₁). In addition, the following syntax and definitions for the scenario are provided:
Syntax. Let [symbol] be the set of nonempty intervals over [symbol] . We often write an interval in [symbol] as [c, d), where cε [symbol] , dε [symbol] ∪{∞}, and c<d, i.e, [c, d):=aε [symbol] |c≦a<d. For the rest of this paper, V denotes a countably infinite set of variables, where we assume that V∩(C∪R)=, for every signature S=(C, R, a).
Definition 1 (FOL): The set of First Order Logic (FOL) formulae over a signature S=(C, R, a) is given by the grammar:

φ_{F::=r}(t₁, . . . tₐ₍ᵣ₎)|( [symbol] φ_{F})|(φ_{F} [symbol] _{φ}_{F})|(φ_{F} [symbol] _{φ}_{F})|(∃φ_{F})
where r ranges over the elements in R, x ranges over V, and I ranges over [symbol] .
Definition 2 (MFOTL): The set of Metric First Order Tem-poral Logic (MFOTL) formulae over a signature S=(C, R, a) is given by the grammar:

φ::=r(t_{1, . . . , a(r)})|( [symbol] φ)|(φ [symbol] φ)|(φ [symbol] φ)|(∃x.φ)|(_{I}φ_{F})|(◯_{I}φ_{F})|(φ_{F}S_{I}φ_{F})|(φ_{F} [symbol] _{I}φ_{F})
where r ranges over the elements in R, x ranges over V, and I ranges over [symbol] .
The classical unary temporal operators are defined as follows:
   ♦_{I}θ:=true S_{I} θ (once), ▪_{I}θ:= [symbol] ♦_{I} [symbol] θ (always in the past), ⋄_{I}θ:=true [symbol] _{I}θ (eventually), and □_{I}θ:= [symbol] ⋄_{I} [symbol] θ (always), where Iε [symbol] .

Events taking place in the actual system may be represented by predicates and the relations between them may be expression with logical operators. The predicates insert, delete, and update may, for instance, represent corresponding Structured Query Language (SQL) statements (e.g., insert[i] (resp. delete[i], update[i]) may denote an insert (resp. delete, update) on database dbᵢ). The following definition for sufficiency of a log set L smaller than a complete log file L_{C} and still provide adequate monitoring by an algorithm A may, for instance, include:
Definition 3 (Sufficiency): Given an MFOTL policy ψ to monitor, a log set [symbol] is sufficient for monitoring by algorithm [symbol] if
   all violations w.r.t. ψ detected by applying [symbol] on [symbol] _{C} are also detected by [symbol] on [symbol] .
   for each violation w.r.t. ψ detected by applying [symbol] over [symbol] , a corresponding violation is detected by [symbol] on [symbol] _{C}.

Given an MFOTL policy ψ, for instance, of the form implication ψ:=rₗ→φ, it is sufficient if details correspond to each predicate rᵢ in ψ. The predicates rᵢ in ψ can be extracted by passing ψ and the regular expression, (insert|delete|update) n[[1−9]*n] n([a−z]*, [a−z]*, [a−z]*n), as input string iStr and input pattern iExp respectively to the parser o₁, o₂, . . . =Parser(iStr, iExp). As indicated, in some circumstances, the output stream of output tokens o₁, o₂, . . . may need to be filtered further to extract the type of action, database instance (numeric value in square brackets) and parameter values (e.g., comma separated values in parenthesis). The filtering can be performed by a series of “split” string operations. As an example, a split function split(iStr, iDelimiter) may outputs two (sub)strings oStr₁ and oStr₂ such that iStr=oStr₁+iDelimiter+oStr₂. As such, the needed values may, for instance, be extracted from the parser output tokens oᵢ as follows:
actionᵢ=oStr₁, oStr₂=split(o₁, ‘[′)
instanceᵢ=oStr₃, oStr₄=split(ostr₂, ‘](′)
userᵢ=oStr₅, oStr₆=split(ostr₄, ‘,′)
tableᵢ=oStr₇, oStr₈=split(ostr₆, ‘,′)
keyᵢ=oStr₉, oStr₁₀=split(ostr₈, ‘)′)

As an example, a policy ψ may require that any insert by user u₁ in table t₁ of database instance db₁ should be replicated in db₂ within 0-30 minutes. As such, the policy ψ may include the following: insert[1](u₁, t₁, unk)→⋄[0, 30]insert[2](u₁, t₁, unk).

While logging all inserts in table t₁ of instances db₁ and db₂ may be “sufficient,” it can be minimized further based on the temporal operator ⋄[0, 30]. The temporal relation ⋄[0, 30] between the two inserts implies that logging an insert in t₁@db₂ is irrelevant with respect to evaluating, if an insert did not occur within the last 30 minutes in t₁@db₁. The intuition here is then to devise a time based real-time mechanism that enables/disables logging based on the temporal operators in the policy to be monitored. For the purpose of illustration, the scenario may be restricted to considering only unary temporal operators Oₜε{♦, ⋄}, where φ is the given MFOTL formula. Note than an MFOTL formula can also have parentheses, which allow a logical/temporal operator to be defined over multiple predicates (also referred to as the scope of the operator). In focusing on temporal operators, the temporal operator Oₜ(rᵢ) enclosing the extracted predicates rᵢ may be determined.

Given ψ:=r₁→φ, let ψ′ denote the transformed MOFTL formula obtained by removing parentheses and distributing temporal operators Oₜ over the predicates rᵢ in their respective scopes. The data extraction itself may, for instance, be achieved by extending the regular expression iExp given as an input to the parser o₁, o₂, . . . =Parser(ψ′, iExp) as follows: ((insert|delete|update) n[[1−9]*n]n([a−z]*, [a−z]*, [a−z]*n))|{♦n[[1−9]*, [1−9]*n|{⋄n[[1−9]*, [1−9]*n]. For each output token oᵢ corresponding to a predicate rᵢ, oᵢ₋₁ corresponds to Oₜ(rᵢ) unless Oₜ(rᵢ)=null (e.g., rᵢ is not bounded by a temporal operator in ψ). As discussed, the output tokens may need to be further filtered to extract the appropriate values from them (e.g., the type of operator (past ♦/future ⋄) and time interval sTime−eTime). Accordingly, for each output token oᵢ corresponding to a temporal operator Oₜ, the following split operations may be applied:
oprᵢ₊₁=oStr₁, oStr₂=split(oᵢ_{_{1 ‘[′)}}
sTimeᵢ₊₁=oStr₃, oStr₄=split(ostr₂, ‘,′)
eTimeᵢ₊₁ oStr₅, oStr₆=split(ostr₄, ‘]′)

For each output token oⱼ corresponding to a predicate rᵢ in ψ, the above filtering leads to oprⱼ [sTimeⱼ, eTimeⱼ] denoting the temporal operator Oₜ(rᵢ). If Oₜ(rᵢ)=null, then set oprⱼ=⋄ and sTimeⱼ=eTimeⱼ=0 as a placeholder denoting the “present” temporal operator. The logging for each rᵢ in ψ such that Oₜ(r₁)=null may, for instance, always be enabled. For each occurrence of r₁ at time point p₁, the logging for each rᵢ in ψ encapsulated by a future temporal operator oprⱼ=⋄ and sTimeⱼ, eTimeⱼ≠0, logging may need to only be enabled for the time interval [p₁+sTimeⱼ, p₁+eTimeⱼ]. Additionally, or alternatively, past temporal operators may be accommodated. For the purpose of illustration, a simplifying assumption is made that for a given MFOTL formula ψ containing n past temporal operators ♦, there exists a ♦[sTimeₘ, eTimeₘ]rₚ in ψ such that (sTimeₘ<sTimeₖ) and (eTimeₘ>eTimeₖ) for all k≠m=1, . . . n. The following algorithm may, for instance, first determine the “maximal” past temporal operator ♦[sTimeₘ, eTimeₘ] in ψ, and then perform the necessary adjustments to other temporal operators in ψ.

Algorithm Aₗ :EIiminate past temporal operators
sTimeₘ = 0, eTimeₘ = 0;
for(i = 1,2,•••)

ifoprᵢ = ♦

if(sTimeᵢ > sTimeₘ) sTimeₘ := sTimeᵢ; fi
if(eTimeᵢ > sTimeₘ) eTimeₘ := eTimeᵢ; fi

fi

endfor
/* Adjust past temporal operators */
for(i = 1,2,•••)

ifoprᵢ = ♦

oprᵢ = ⋄;
sTimeᵢ := (sTimeₘ − sTimeᵢ);
eTimeᵢ := (eTimeₘ − eTimeᵢ);

fi

/* Adjust present and future temporal operators */

ifoprᵢ = ⋄

sTimeᵢ := (sTimeᵢ + sTimeₘ);
eTimeᵢ := (eTimeᵢ + eTimeₘ);

fi

fi

endfor

It is noted that the above algorithm also converts the maximal past temporal operator ♦[sTimeₘ, eTimeₘ]rₚ, to present ⋄[0, 0]rₚ. Let the MFOTL formula obtained by applying algorithm A₁ be ψ″. All predicates rᵢ in ψ″ are then encapsulated by future temporal operators, except rₚ which has a present temporal operator.

In another scenario, the compliance platform 103 may call an auditing specification generation function AuditGen( ) to determine and generate the auditing specifications. AuditGen( ) may, for instance, take as inputs the output tokens from a parsing function (e.g., Parser(iStr, iExp)). The AuditGen( ) function may then transform given MFOTL policy predicates into auditing specifications that can be given as input directly to the database instances to produce the necessary logs for policy verification. By way of example, the auditing specification generation function AuditGen(oᵢ::=[actionᵢ, instanceᵢ, userᵢ, tableᵢ, keyᵢ) may create a server audit object and a database auditing specification object. The server audit object may, for instance, be created based on the following SQL code:

IF NOT EXISTS
BEGIN

Create Server Audit SA_V
To File ([File Location]; Size])
On Failure = Continue

END
ELSE

PRINT ‘Server Audit Exists’

The database auditing specification object may, for instance, be created based on the following SQL code:

Use instanceᵢ
IF NOT EXISTS
BEGIN

Create Database Audit Specification V
For Server Audit SA_V

Add (actionᵢ
On tableᵢ
By userᵢ)
With (State = On)

END
ELSE

PRINT ‘Database Audit already Exists’

In a further scenario, relevant data from log files may be extracted. The various details included in these log files may, for instance, include: (a) the date and time of the event (e.g., operations); (b) whether the action succeeded (or permissions were denied); (c) the actual SQL statement that triggered the audit event (if applicable); (d) the connection context (server and instance, database schema); (e) the audit file name and the position of the audit record in the file; or (f) any other relevant information.

By way of example, the UE 101, the compliance platform 103, the service platform 113, the services 115, and the content providers 117 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

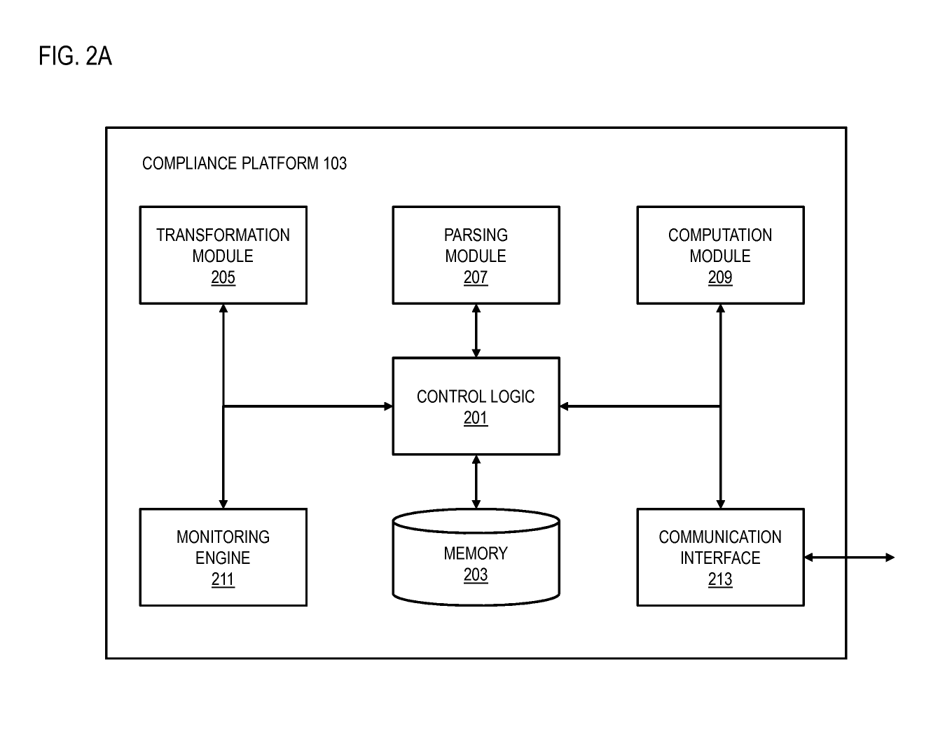

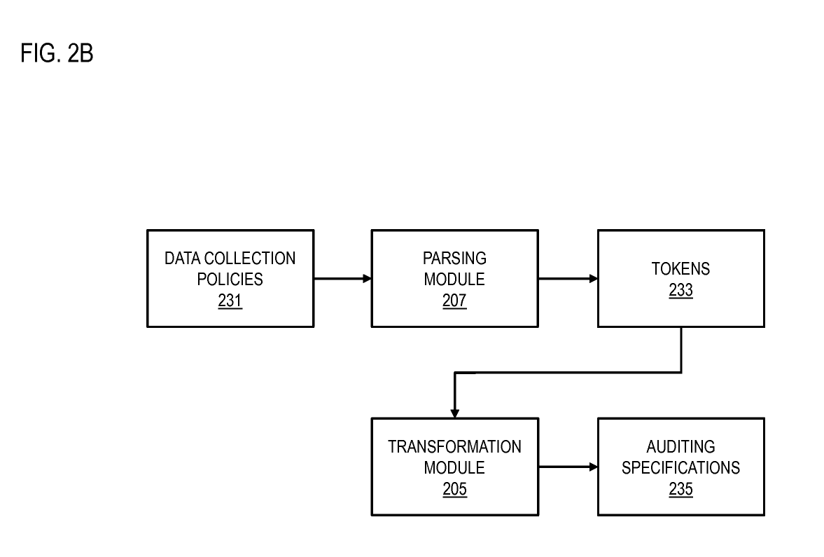

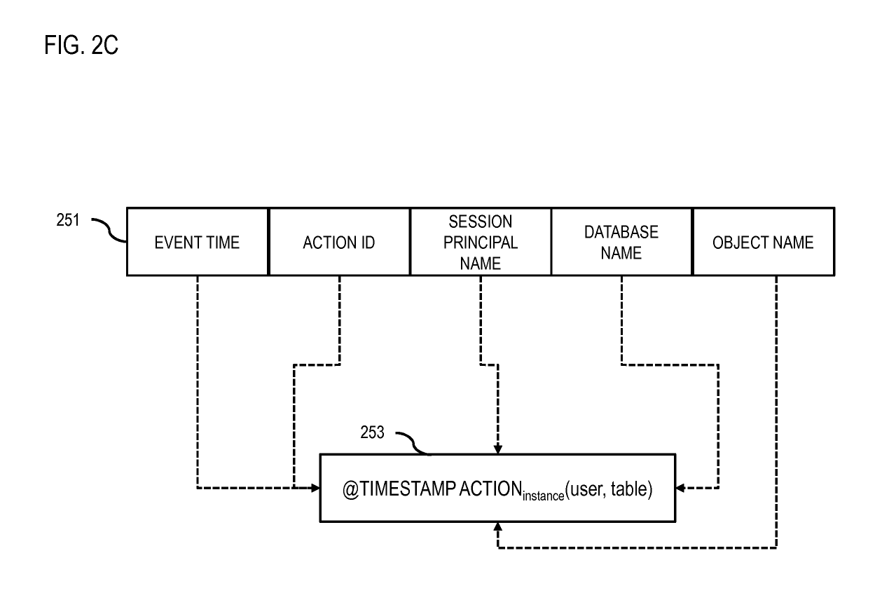

FIG. 2A is a diagram of the components of a compliance platform, according to one embodiment. By way of example, the compliance platform 103 includes one or more components for generating auditing specifications. It is contemplated that the functions of these components may be combined in one or more components or performed by other components of equivalent functionality. In this embodiment, the compliance platform 103 includes control logic 201, memory 203, a transformation module 205, a parsing module 207, a computation module 209, a monitoring engine 211, and a communication interface 213.

The control logic 201 executes at least one algorithm for executing functions of the compliance platform 103. For example, the control logic 201 may interact with the transformation module 205 to process data collection policies to determine auditing specifications that specify data to log for determining a compliance with the data collection policies. The transformation module 205 may, for instance, work with the parsing module 207 to determine the data collection policies in a predetermined format, a policy language, a high level language, etc., and then parse the data collection policies according to the predetermined format, the policy language, the high level language, etc., to determine the auditing specifications.

The transformation module 205 may also determine contextual parameters, such as temporal parameters, location parameters, activity parameters, etc., associated with the data collection policies. Thus, the auditing specifications may be determined based on the contextual parameters. When the auditing specifications are determined, the transformation module 205 may trigger an installation of the auditing specifications at data stores operating under the data collection policies to initiate a logging of the data.

The control logic 201 may then direct the computation module 209 to process the data for comparison against the data collection policies, the auditing specifications, etc., to determine the compliance with the data collection policies. The computation module 209 may, for instance, compare operations performed on the data stores by applications, services, third parties, etc., against policy-monitored operations to determine whether the performed operations are in compliance with the data collection policies.

The control logic 201 may further employ the monitoring engine 211 to generate notifications, reports, etc., with respect to the compliance with the data collection policies. As indicated, different levels of scrutiny may apply based on the particular operations performed on the data stores. Therefore, the monitoring engine 211 may generate notifications, reports, etc., based on the particular level of scrutiny applied to the various performed operations (e.g., high-priority notifications for operations associated with a high-level of scrutiny).

The control logic 201 may also utilize the communication interface 213 to communicate with other components of the compliance platform 103, the UEs 101, the service platform 113, the services 115, the content providers 117, and other components of the system 100. For example, the communication interface 213 may transmit the generated notifications to the responsible policy officers, policy managers, etc., via their respective UEs 101. The communication interface 213 may further include multiple means of communication. In one use case, the communication interface 213 may be able to communicate over short message service (SMS), multimedia messaging service (MMS), internet protocol, instant messaging, voice sessions (e.g., via a phone network), or other types of communication.

FIG. 2B is an illustration of a flowchart using the components of a compliance platform, according to one embodiment. As shown, data collection policies 231 may be given as inputs to the parsing module 207 along with other inputs (e.g., a regular expression) to generate output tokens 233, which may be provided to the transformation module 205. Based on the output tokens 233, for instance, the transformation module 205 may determine the auditing specifications 235 specifying the data to log. As such, the auditing specifications 235 may then be installed at data stores operating under the data collection policies 231.

FIG. 2C is an diagram of various details that may be extracted from an audit output file, according to one embodiment. As illustrated, the audit output file 251 includes the event time (e.g., time of the operation), an action identifier (e.g., associated with the SQL statement that triggered the audit event), the session principal name, the database name, and the object name. These details, along with other details, may be extracted by the function 253 to produce the relevant log files. Although the details may initially be extracted as binary data, the function 253 may transform and save the logged data in specific file formats, such as .txt, .cvs, .xml or xls file formats.

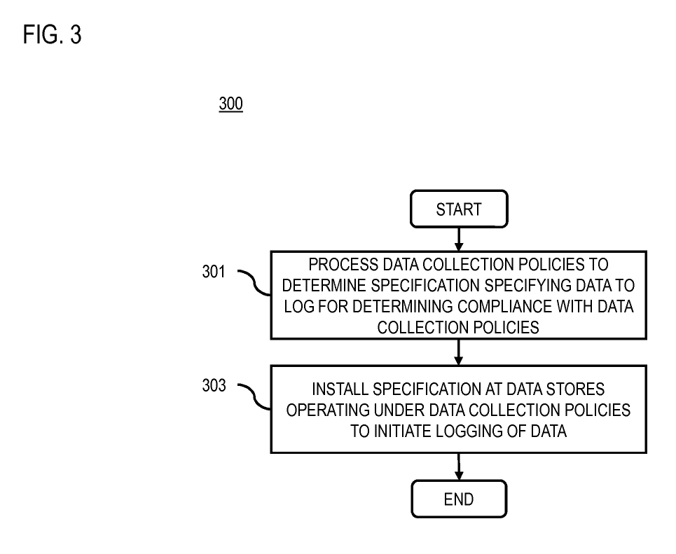

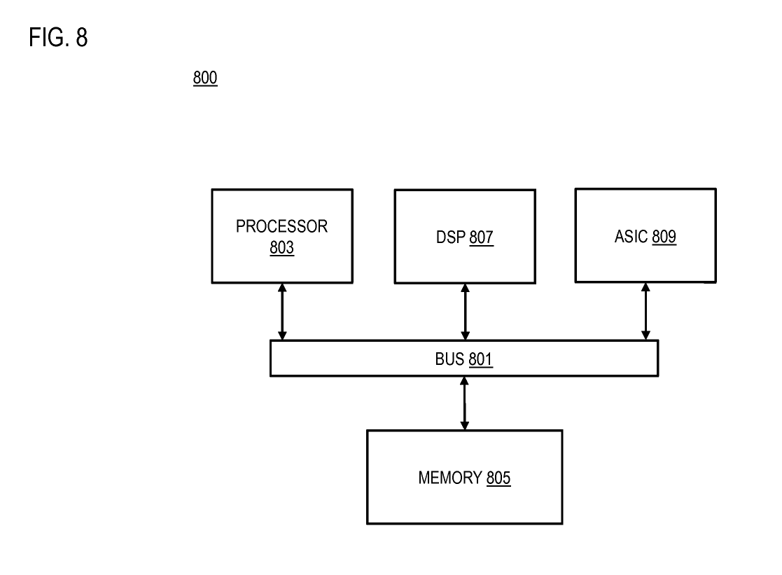

FIG. 3 is a flowchart of a process for generating auditing specifications, according to one embodiment. In one embodiment, the compliance platform 103 performs the process 300 and is implemented in, for instance, a chip set including a processor and a memory as shown in FIG. 8. As such, the control logic 201 can provide means for accomplishing various parts of the process 300 as well as means for accomplishing other processes in conjunction with other components of the compliance platform 103.

In step 301, the control logic 201 may process and/or facilitate a processing of one or more data collection policies to determine one or more specifications that specify, at least in part, data to log for determining a compliance with the one or more data collection policies. As discussed, the one or more data collection policies may, for instance, include one or more privacy policies, one or more security policies, one or more performance policies, or a combination thereof. In one scenario, a data collection policy may be determined to be in a particular predetermined format, a policy language, a high level language, etc. If, for instance, the data collection policy is determined to be in MFOTL, then the data collection policy may be parsed according a format or syntax associated with MFOTL to generate the corresponding specification.

In step 303, the control logic 201 may cause, at least in part, an installation of the one or more specifications at one or more data stores operating under the one or more data collection policies to cause, at least in part, an initiation of a logging of the data. The data to log may, for instance, include data related to one or more operations performed on the one or more data stores including, at least in part, one or more transfers, one or more modifications, one or more utilizations, one or more accesses, or a combination thereof. In this way, the logging of the data may commence upon the installation of the one or more specifications at the one or more data stores since the data to log is already specified in the one or more specifications.

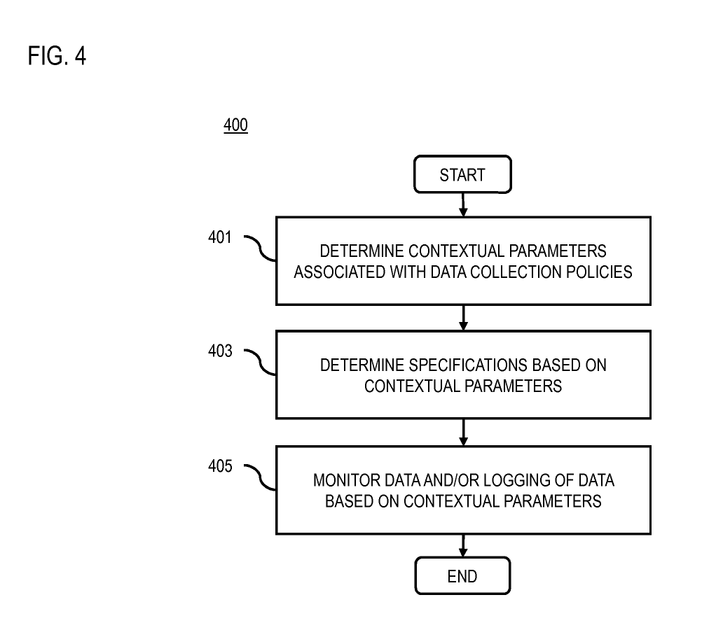

FIG. 4 is a flowchart of a process for providing auditing specifications based on contextual parameters, according to one embodiment. In one embodiment, the compliance platform 103 performs the process 400 and is implemented in, for instance, a chip set including a processor and a memory as shown in FIG. 8. As such, the control logic 201 can provide means for accomplishing various parts of the process 400 as well as means for accomplishing other processes in conjunction with other components of the compliance platform 103.

In step 401, the control logic 201 may determine one or more contextual parameters associated with the one or more data collection policies. The one or more contextual parameters may, for instance, include one or more temporal parameters, one or more location parameters, and/or one or more activity parameters. As such, the control logic 201 may then, as in step 403, determine the one or more specifications based, at least in part, on the one or more contextual parameters. As mentioned, in some embodiments, the one or more contextual parameters may be utilized to minimize the amount of data to be logged.

In step 405, the control logic 201 may determine to monitor the data, the logging of the data, or a combination thereof based, at least in part, on the one or more contextual parameters. By way of example, one or more entries of one or more data logs may be generated based on the logging of the data. The one or more entries may be processed to monitor the data, the logging of the data, or a combination thereof. In one scenario, the processing of the one or more entries may determine that a predetermined threshold with respect to a number of violations satisfying a particular contextual parameter (e.g., data transfers outside one or more trusted geographical regions) has been reached. As such, a report including the entries that indicate violations satisfying the particular contextual parameter may be generated and a notification may be transmitted to a high-level policy manager as an alert to signify non-compliance with the data collection policies.

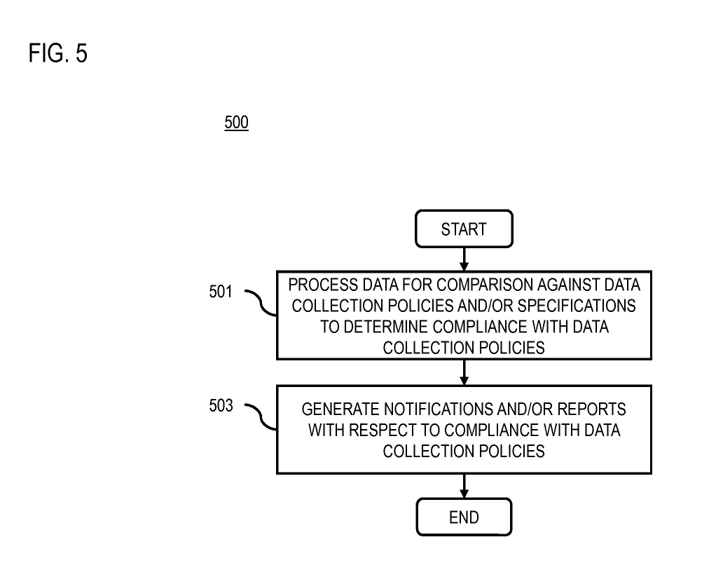

FIG. 5 is a flowchart of a process for generating compliance notifications and reports, according to one embodiment. In one embodiment, the compliance platform 103 performs the process 500 and is implemented in, for instance, a chip set including a processor and a memory as shown in FIG. 8. As such, the control logic 201 can provide means for accomplishing various parts of the process 500 as well as means for accomplishing other processes in conjunction with other components of the compliance platform 103.

In step 501, the control logic 201 may process and/or facilitate a processing of the data for comparison against the one or more data collection policies, the one or more specifications, or a combination thereof to determine the compliance with the one or more data collection policies. As discussed, in some embodiments, data related to the one or more operations performed on the one or more data stores by one or more applications, one or more services, one or more third parties may be compared against one or more policy-monitored operations to determine whether the one or more performed operations are in compliance. In one scenario, the data collection policies associated with a particular data store may forbid transfers of collected user-identifiable information to third parties. Thus, the data collection policies may require removal of collected user-identifiable information from a subset of collected user data prior to the transfer of that subset a third party. Accordingly, such data transfers to third parties may be monitored for user-identifiable information to determine compliance with the data collection policies.

The control logic 201 may, in step 503, further cause, at least in part, a generation of one or more notifications, one or more reports, or a combination thereof with respect to the compliance with the one or more data collection policies. In a further scenario, a high-level of scrutiny may apply to violations with respect to a requirement that user-identifiable information must be removed from collected information prior to a data transfer of that collected information to third parties. Accordingly, transfers of user-identifiable information to third parties may trigger a notification that includes information relating to the particular transfer to be generated and transmitted to all high-level policy managers.

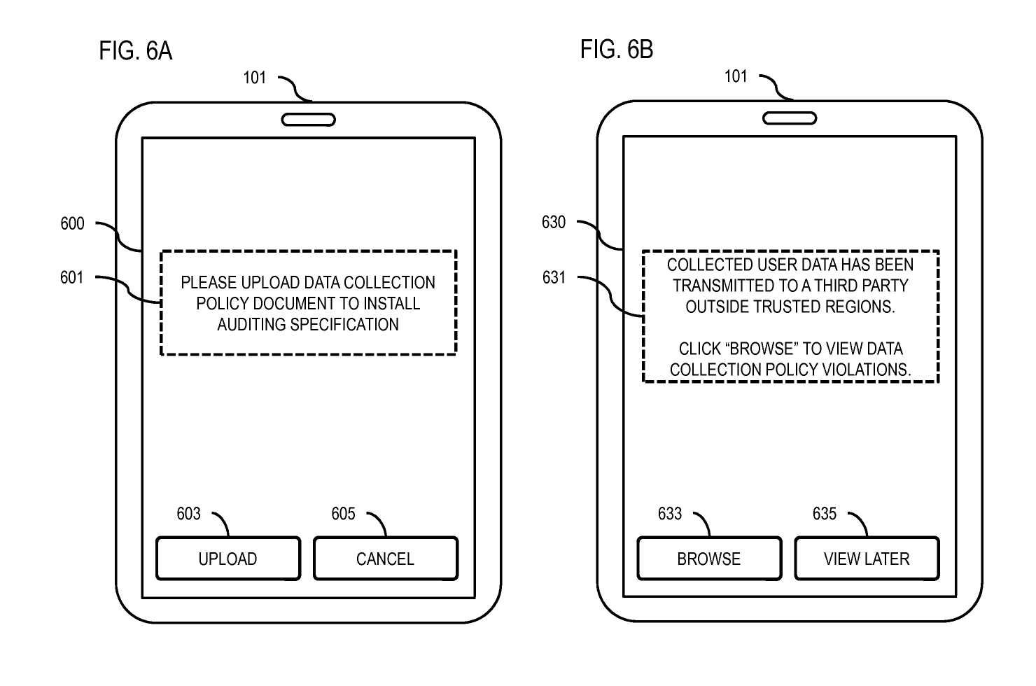

FIGS. 6A and 6B are diagrams of user interfaces utilized in the processes of FIGS. 3-5, according to various embodiments. FIG. 6A features the UE 101 utilizing a user interface 600 (e.g., of the application 107), which illustrates a notification 601 as well as options 603 and 605. As shown, the user (e.g., a privacy officer, a privacy manager, etc.) is presented with the notification 601 to upload a document for a particular data collection policy to install a corresponding auditing specification, for instance, on one or more data stores designated to operate under the data collection policy. If the user selects the option 603 (e.g., “Upload”), the user may browse for and select the document containing the data collection policy. The data collection policy may then be processed to generate the corresponding auditing specification that specify data to log for determining a compliance with the data collection policy. The generated auditing specification may thereafter be installed at the data stores designated to operate under the data collection policy to initiate logging of the data. As discussed, the generation of the auditing specification and the installation of the generated auditing specification may be automated without user action upon, for instance, receipt of the data collection policy for processing (e.g., when the document for the data collection policy is uploaded). By way of example, the automated process may include a parser (e.g., parsing module 207) that takes as input the data collection policy and outputs tokens, and a transformation module (e.g., transformation module 205) that takes those tokens as input and outputs the auditing specification. In this way, a privacy officer would not need to manually write the auditing specification, or manually determine and select the particular data to be logged.

FIG. 6B features the UE 101 utilizing a user interface 630, which illustrates a notification 631 as well as options 633 and 635. As mentioned, the compliance platform 103 may initiated logging of the data upon the installation of the auditing specification. The auditing specification may, for instance, be based on certain contextual parameters (e.g., temporal parameters, location parameters, activity parameters, etc.), which may be utilized to minimize the amount of the data to be logged. In some embodiments, data related to operations performed on the data stores (e.g., by applications, services, third parties, etc.) may be compared against policy-monitored operations to determine the compliance with the data collection policy. As shown, in this scenario, the data collection policy may forbid certain transfers of collected user data to third parties outside trusted regions (e.g., trusted network regions). If, for instance, such data transfers are initiated, the compliance platform 103 may generate a notification, such as the notification 631, to indicate that such violation has occurred, and transmit the notification to one or more responsible parties. As shown, the user (e.g., one of the responsible parties) may select the option 633 to browse the violations or the option 635 to view the violations at a later time.

The processes described herein for generating auditing specifications may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

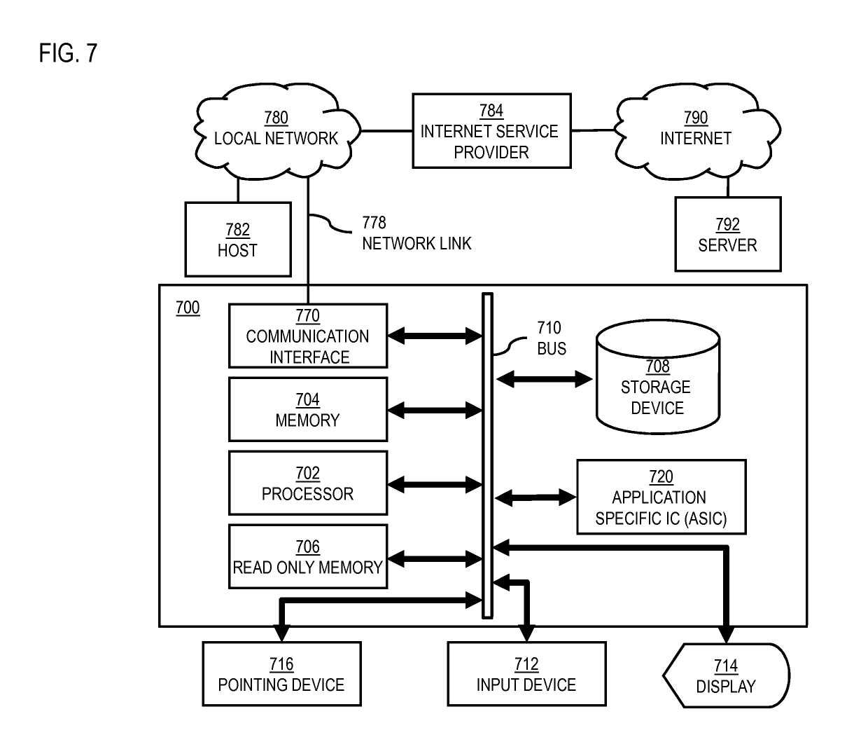

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to generate auditing specifications as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero-electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of generating auditing specifications.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to generating auditing specifications. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for generating auditing specifications. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for generating auditing specifications, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a Mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for generating auditing specifications to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in tarrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to generate auditing specifications as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of generating auditing specifications.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to generate auditing specifications. The memory 805 also stores the data associated with or generated by the execution of the inventive steps.

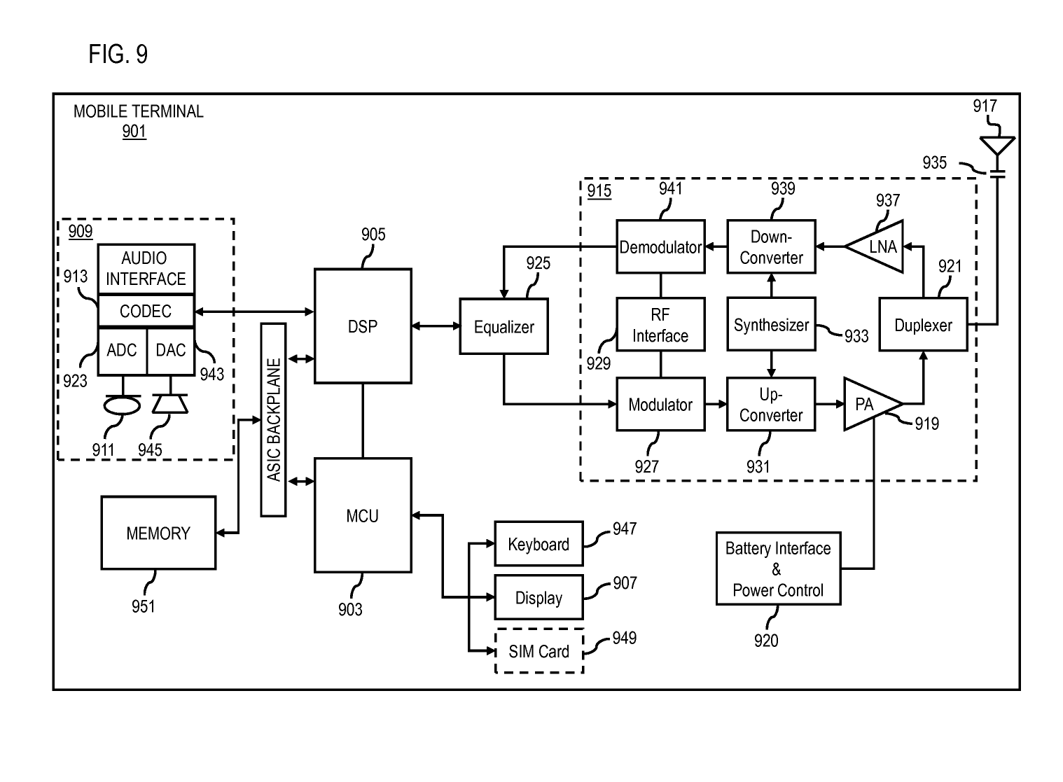

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of generating auditing specifications. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of generating auditing specifications. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to generate auditing specifications. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a processing of one or more data collection policies to determine one or more specifications that specify, at least in part, data to log for determining a compliance with the one or more data collection policies; and
an installation of the one or more specifications at one or more data stores operating under the one or more data collection policies to cause, at least in part, an initiation of a logging of the data.

2. A method of claim 1, wherein the (1) data and/or (2) information and/or (3) at least one signal are further based, at least in part, on the following:
a processing of the data for comparison against the one or more data collection policies, the one or more specifications, or a combination thereof to determine the compliance with the one or more data collection policies.

3. A method of claim 1, wherein the (1) data and/or (2) information and/or (3) at least one signal are further based, at least in part, on the following:
a generation of one or more notifications, one or more reports, or a combination thereof with respect to the compliance with the one or more data collection policies.

4. A method of claim 1, wherein the (1) data and/or (2) information and/or (3) at least one signal are further based, at least in part, on the following:
at least one determination of the one or more specifications based, at least in part, on minimizing an amount of the data to log.

5. A method of claim 1, wherein the (1) data and/or (2) information and/or (3) at least one signal are further based, at least in part, on the following:
at least one determination of the one or more data collections policies in a predetermined format, a policy language, a high level language, or a combination thereof; and
causing, at least in part, a parsing of the one or more data collection policies according to the predetermined format, the policy language, the high level language, or a combination thereof to determine the one or more specifications.

6. A method of claim 1, wherein the (1) data and/or (2) information and/or (3) at least one signal are further based, at least in part, on the following:
at least one determination of one or more contextual parameters associated with the one or more data collection policies; and
at least one determination of the one or more specifications based, at least in part, on the one or more contextual parameters.

7. A method of claim 6, wherein the (1) data and/or (2) information and/or (3) at least one signal are further based, at least in part, on the following:
at least one determination to monitor the data, the logging of the data, or a combination thereof based, at least in part, on the one or more contextual parameters.

8. A method of claim 6, wherein the one or more contextual parameter include, at least in part, one or more temporal parameters, one or more location parameters, one or more activity parameters, or a combination thereof.

9. A method of claim 1, wherein the one or more data collection policies include, at least in part, one or more privacy policies, one or more security policies, one or more performance policies, or a combination thereof, and wherein the one or more specifications include, at least in part, one or more auditing specifications.

10. A method of claim 1, wherein the data to log include, at least in part, data related to one or more operations performed on the one or more data stores including, at least in part, one or more transfers, one or more modifications, one or more utilizations, one or more accesses, or a combination thereof.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of one or more data collection policies to determine one or more specifications that specify, at least in part, data to log for determining a compliance with the one or more data collection policies; and
cause, at least in part, an installation of the one or more specifications at one or more data stores operating under the one or more data collection policies to cause, at least in part, an initiation of a logging of the data.

12. An apparatus of claim 11, wherein the apparatus is further caused to:
process and/or facilitate a processing of the data for comparison against the one or more data collection policies, the one or more specifications, or a combination thereof to determine the compliance with the one or more data collection policies.

13. An apparatus of claim 11, wherein the apparatus is further caused to:
cause, at least in part, a generation of one or more notifications, one or more reports, or a combination thereof with respect to the compliance with the one or more data collection policies.

14. An apparatus of claim 11, wherein the apparatus is further caused to:
determine the one or more specifications based, at least in part, on minimizing an amount of the data to log.

15. An apparatus of claim 11, wherein the apparatus is further caused to:
determine the one or more data collections policies in a predetermined format, a policy language, a high level language, or a combination thereof; and
cause, at least in part, a parsing of the one or more data collection policies according to the predetermined format, the policy language, the high level language, or a combination thereof to determine the one or more specifications.

16. An apparatus of claim 11, wherein the apparatus is further caused to:
determine one or more contextual parameters associated with the one or more data collection policies; and
determine the one or more specifications based, at least in part, on the one or more contextual parameters.

17. An apparatus of claim 16, wherein the apparatus is further caused to:
determine to monitor the data, the logging of the data, or a combination thereof based, at least in part, on the one or more contextual parameters.

18. An apparatus of claim 16, wherein the one or more contextual parameter include, at least in part, one or more temporal parameters, one or more location parameters, one or more activity parameters, or a combination thereof.

19. An apparatus of claim 11, wherein the one or more data collection policies include, at least in part, one or more privacy policies, one or more security policies, one or more performance policies, or a combination thereof, and wherein the one or more specifications include, at least in part, one or more auditing specifications.

20. An apparatus of claim 11, wherein the data to log include, at least in part, data related to one or more operations performed on the one or more data stores including, at least in part, one or more transfers, one or more modifications, one or more utilizations, one or more accesses, or a combination thereof.

21-48. (canceled)
